(19) United States
(12) Patent Application Publication
(10) Pub. No.: US 2022/0143870 A1
(43) Pub. Date: May 12, 2022

(54) A Handheld Cut-Off Saw for Cutting Concrete and Stone, Comprising a Drive Arrangement for Driving A Circular Cutting Tool

(71) Applicant: HUSOVARNA AB, HUSKVARNA (SE)

(72) Inventors: Håkan Pinzani, Göteborg (SE); Niklas Sundberg, Alingsås (SE); Fredrik Karlsson, Kullegärdet 59 (SE)

(21) Appl. No.: 17/431,946

(22) PCT Filed: Feb. 20, 2020
(86) PCT No.: PCT/SE2020/050197

§ 371 Date: Aug. 18, 2021

(30) Foreign Application Priority Data
Feb. 21, 2019 (SE) 1950229-3

(51) Int. Cl. B28D 1/04; B23Q 5/04

(52) U.S. Cl. CPC B28D 1/045; B23Q 5/04

(57) ABSTRACT

A handheld cut-off saw (300) for cutting concrete and stone, the handheld cut-off saw comprising a drive arrangement (100, 200, 600, 800) for driving a circular cutting tool (110), the drive arrangement comprising: a belt drive portion (120) comprising a first pulley (121) and a second pulley (122), wherein the first pulley is arranged to be powered by a power source (130) and to drive the second pulley via a belt (123), wherein the second pulley (122) has a larger pitch diameter than the first pulley (121); and a gear transmission portion (140) comprising a first gearwheel (141) and a second gearwheel (142), wherein the first gearwheel (141) is co-axially connected to the second pulley (122) and radially connected to the second gearwheel (142), and wherein the second gearwheel (142) is arranged to be co-axially connected to the circular cutting tool (110).

### TECHNICAL FIELD

There are disclosed drive arrangements for powering rotatable work tools. The present disclosure relates mainly to power tools such as cut-off saws.

### BACKGROUND

Dust is often generated in large amounts when cutting concrete, stone, and other hard materials using a power tool. Such air-borne dust can be harmful to an operator and often necessitates extensive cleaning of the workplace after cutting. It is therefore desired to minimize the amount of air-borne dust.

Water or other liquids can be added to the cutting tool during the cutting operation to bind the airborne dust. This makes the cutting environment less harmful to the operator, and also prevents the airborne dust from spreading over a large area.

It is known to arrange a liquid dispensing system on a power tool in order to reduce the amount of generated dust. U.S. Pat. No. 9,604,297 B2 discloses a liquid dispensing system for adding a controlled amount of liquid to a rotatable work tool.

However, it is not always desirable or even possible to add liquid during the cutting operation. Dry cutting is then an option. When dry cutting a material with a power tool, it is advantageous to reduce the rotational speed of the tool, since a reduced blade speed does not propel dust particles as much and therefore makes it easier to collect the generated dust using, e.g., a vacuum system or the like.

Unfortunately, power sources such as electrical motors and combustion engines operating at reduced engine speeds are more costly and often also weighs more than standard motors operating around 9000-10000 revolutions per minute (rpm). Various forms of transmission systems having a gear ratio for lowering the speed of the motor drive shaft are therefore often used in dry cutting power tools.

It is known to reduce blade speed using a drive belt with a smaller pulley connected to the motor drive shaft and a larger pulley connected to the work tool. However, having a large pulley close to the work tool may negatively impact the achievable cutting depth of the tool. Also, the belt will be subject to a large torque force, which increases requirements on belt dimensions.

There is a need for power tool drive arrangements which provide reduced blade speeds while maintaining cutting depth, and which do not require reducing engine drive shaft speeds.

### SUMMARY

It is an object of the present disclosure to provide improved drive arrangements, power tools, and methods which allow for reduced blade speeds. It is a further object of the present disclosure to optimize cutting depth.

These objects are at least in part obtained by a drive arrangement for driving a rotatable work tool. The drive arrangement comprises a belt drive portion with a first pulley and a second pulley. The first pulley is arranged to be powered by a power source and to drive the second pulley via a belt. The second pulley has a larger pitch diameter than the first pulley. The drive arrangement also comprises a gear transmission portion comprising a first gearwheel and a second gearwheel. The first gearwheel is co-axially connected to the second pulley and radially connected to the second gearwheel. The second gearwheel is arranged to be co-axially connected to the rotatable work tool.

Thus, as the first pulley is rotated, force is transferred to the work tool via the belt and gears. The work tool is brought in rotation in an opposite direction compared to the first pulley.

This drive arrangement provides for an efficient way to reduce tool speed down to speeds suitable for dry cutting operation. The generated dust is propelled at reduced speed, giving slower moving dust particles that are more easily handled, which is an advantage.

The combination of belt drive and gear transmission allow for design freedom, as will be exemplified in the below detailed description. For instance, the requirements on belt drive dimensions can be relaxed due to the gear transmission portion. Also, the work tool can be stopped abruptly without exerting excessive forces on, e.g., the belt drive portion.

By means of the disclosed drive arrangement, requirements on engine power output can be relaxed, which is an advantage.

According to aspects, the second gearwheel has a pitch diameter smaller than a pitch diameter of the second pulley. A smaller second gearwheel diameter provides for an increased cutting depth, which is an advantage.

According to some aspects, a distance D1 from a center axis of the first pulley to a center axis of the second pulley is smaller than a distance D2 from the center axis of the first pulley to a center axis of the second gearwheel.

In other words, the second pulley has been moved away from the cutting edge of the tool. The large second pulley therefore no longer limits the cutting depth of the work tool, which is an advantage.

According to some aspects, the second gearwheel has a larger pitch diameter compared to the first gearwheel.

This way the gear transmission provides a further reduction in speed. The gear ratio also reduces mechanical stress exerted on the belt in the belt drive portion, which is an advantage. For instance, it becomes possible to quickly stop the tool in an emergency situation without over dimensioning the belt.

According to some other aspects, the second gearwheel has an equal or smaller pitch diameter compared to the first gearwheel.

This way the gear transmission portion removes some of the speed reduction achieved by the belt drive portion which may be a disadvantage. However, advantageously, the second gearwheel now becomes smaller, which may further increase the attainable cutting depth of the tool.

The disclosed drive arrangements are particularly suitable for use with electric motors, which can be designed to operate in both clockwise and counterclockwise direction. However, the drive arrangements can also be used with conventional combustion engines, or with hybrid electric combustion engines.

According to an example, a drive ratio of the overall drive arrangement is between 1:3 and 1:4, and preferably between 1:3.0 and 1:3.5, and more preferably 1:3.2. This means that a power source can be arranged to operate at between 9000 and 10000 rpm giving a rotatable work tool speed at between 2500 and 5000 rpm, and preferably around 3000 rpm, which are suitable speeds for dry cutting.

There are also disclosed herein power tools, blade guards, and methods associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described more in detail with reference to the appended drawings, where:

FIGS. 1-2 schematically illustrate drive arrangements for a power tool;

FIG. 3 shows an example power tool;

FIG. 4 schematically illustrates an example blade guard for a power tool;

FIGS. 5-6 schematically illustrate drive arrangements for a power tool;

FIG. 7 is a flow chart illustrating methods; and

FIGS. 8-11 schematically illustrate an example drive arrangement for a power tool.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

A belt drive arrangement can be configured to provide a drive ratio which reduces the rotational speed of an engine drive shaft down to a speed suitable for dry cutting. Such gear ratios necessitate using a smaller pulley at the drive shaft to drive a larger pulley connected to the work tool. However, if the larger pulley is co-axially attached directly to the rotatable work tool, then the attainable cutting depth may be reduced by the large belt pulley.

The drive arrangements discussed herein are based on a combination of a drive belt portion and a gear transmission portion; To avoid reduced cutting depth, the large belt pulley is instead used to drive a first gearwheel in a gear transmission portion of the drive arrangement. The first gearwheel then drives a second gearwheel which is coaxially attached to the rotatable work tool. The large pulley can then be displaced away from the cutting edge of the work tool, up to a distance determined by the gearwheel dimensions, thereby avoiding the limitation of cutting depth by the large pulley.

Only two pulleys and two gearwheels are necessary in the drive arrangements discussed herein. The power source used to power the rotatable work tool is arranged to rotate in a direction opposite to that of the work tool. This is not a problem when using an electrical motor as a power source, which can be configured to rotate in any direction. Thus, the disclosed drive arrangements are especially suited for use with electrical motors.

It is appreciated that the drive arrangements discussed herein can also be used with combustion engines.

JP3002414U discloses a drive arrangement comprising a combination of a belt drive portion and a gear transmission portion.

DE416354A also describes a drive arrangement comprising a combination of a belt drive portion and a gear transmission portion.

However, neither JP3002414U nor DE416354A discloses a drive arrangement like the drive arrangements discussed herein, which only require two pulleys and two gear wheels. Also, the purpose of maximizing cutting depth is not mentioned in the prior art documents.

It is appreciated that specification of the size of gears and pulleys is not straight forward. The present disclosure therefore adopts a simplified definition of gear and pulley diameter, which determine drive ratio;

Standard reference pitch diameter is the diameter of the standard pitch circle. In spur and helical gears, the standard pitch diameter is related to the number of teeth and the standard transverse pitch. The diameter can be roughly estimated by taking the average of the diameter measuring the tips of the gear teeth and the base of the gear teeth.

The pitch diameter of a pulley is not the outside diameter, nor the inside diameter. If a belt is cut and the end section observed, a row of fibers is normally visible near the outside surface. This is the tension carrying part of the belt; the rest of the belt exists only to carry the forces from the pulley to and from these fibers. The pitch diameter of a pulley is measured at these fibers. Therefore, the pitch diameter of a pulley depends not just on the pulley itself, but on the width of the belt.

The ratio of pitch diameters is called the drive ratio or gear ratio, the ratio by which torque is increased and speed is decreased, or vice versa. Power is the product of speed and force, or in the case of things that spin, speed and torque. Pulleys and gear transmission do not affect power (not accounting for friction and the like); when they increase torque, it is at the expense of speed, and vice versa.

Herein, for simplicity, the sizes of both pulleys and gearwheels are indicated in terms of ‘pitch diameter’. It is appreciated that a small pitch diameter wheel driving a larger pitch diameter wheel gives rise to a reduction in speed and an increase in torque. Methods for determining exact pitch diameters which provide a wanted gear ratio are known and will not be discussed in more detail herein. Methods for determining necessary specifications of, e.g., a drive belt to be able to withstand a specific range of torque forces are also known and will not be discussed in more detail here.

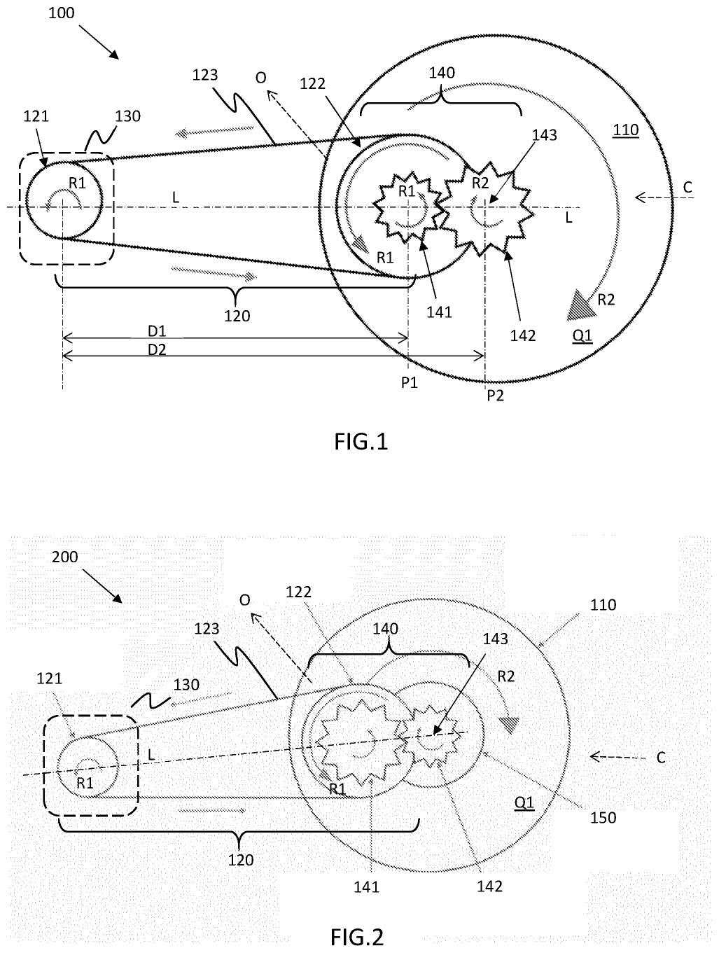

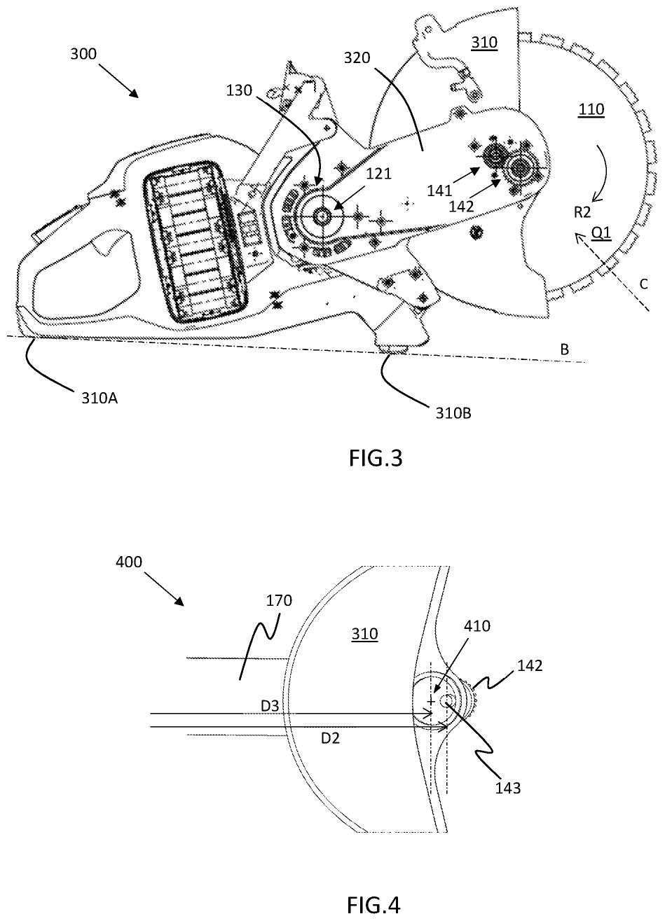

FIG. 1 shows a drive arrangement 100 for driving a rotatable work tool 110. An example power tool comprising a rotatable work tool driven by the drive arrangement will be discussed in connection to FIG. 3 below.

The present disclosure relates mainly to power tools such as cut-off saws, although aspects of the described drive arrangements are potentially applicable for use in abrasive chainsaws, ring saws, hole saws, drills, and other rotatable work tools.

The drive arrangement 100 comprises a belt drive portion 120. The belt drive portion comprises a first pulley 121 and a second pulley 122. The first pulley is arranged to be powered by a power source 130 (only schematically shown in FIG. 1).

To reduce blade speed with respect to a rotational speed of the first pulley, the second pulley has a larger pitch diameter than the first pulley. This drive ratio increases torque and reduces speed making the rotatable work tool suitable for dry cutting operation.

The drive arrangement 100 also comprises a gear transmission portion 140. The gear transmission portion comprises a first gearwheel 141 and a second gearwheel 14. The first gearwheel 141 is co-axially connected to the second pulley 122 and the second gearwheel 142 is arranged to be co-axially connected to the rotatable work tool 110. Thus, as the first pulley is rotated, a belt (not shown in FIG. 1) drives the second pulley in the same direction of rotation. The second pulley, being co-axially connected to the first gearwheel, then drives the first gearwheel in the same direction of rotation as the first pulley. The first gearwheel is radially connected to the second gearwheel, and therefore drives the second gearwheel in an opposite direction of rotation. Thus, the direction of rotation R1 of the first pulley 121 and the direction of rotation R2 of the work tool 110 are opposite to each other.

In other words, according to some aspects, a direction of rotation R1 of a drive shaft of the power source 130 is opposite to a direction of rotation R2 of the rotatable work tool 110.

According to some aspects, the power source 130 is arranged to operate at between 9000 and 10000 rpm, and the rotatable work tool is driven at around 4000-5000 rpm. Thus, the rotatable work tool is suitable for dry cutting operation, and a standard sized motor can be used. This is an advantage due to both cost and weight reasons.

According to some aspects, a distance D1 from a center axis of the first pulley 121 to a center axis of the second pulley 122 is smaller than a distance D2 from the center axis of the first pulley 121 to a center axis 143 of the second gearwheel 142. This means that the second pulley has been positioned with an offset in a direction C away from a cutting region of the work tool. Thus, the larger second pulley 122 is no longer directly limiting the cutting depth of the work tool 110.

It is appreciated that, normally, the rotation axes of the first pulley 121, the second pulley 122, the first gearwheel 141 and the second gearwheel 142 are arranged parallel to each other.

According to some aspects, the rotation axes of the first pulley 121, the second pulley 122, the first gearwheel 141 and the second gearwheel 142 are arranged on a straight line L as shown in FIG. 1. This arrangement provides for a relatively narrow support structure which holds the tool, which could be an advantage.

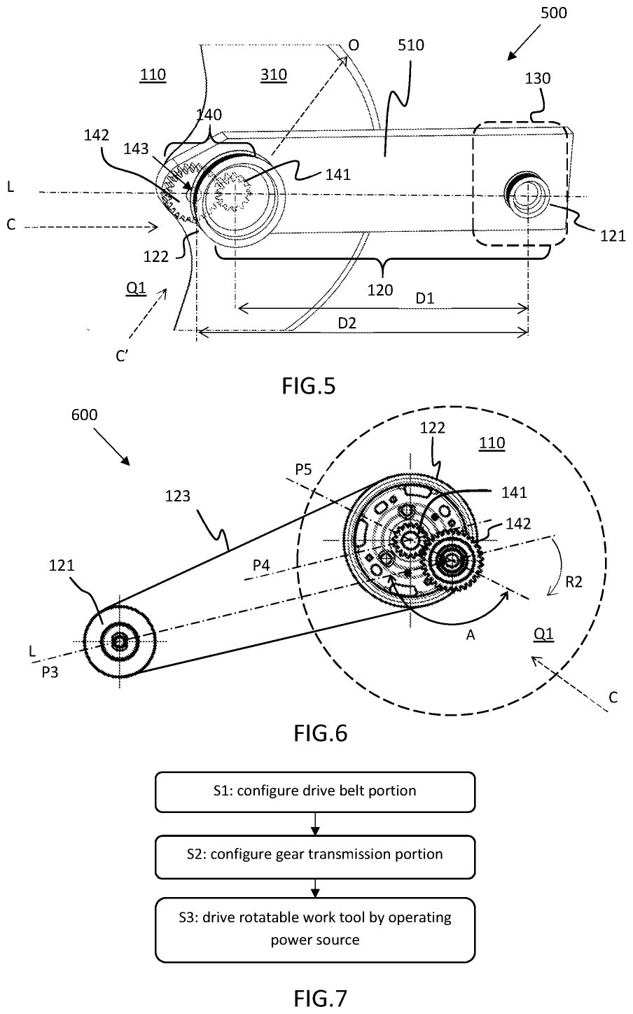

It is, however, appreciated that it may be advantageous to bias the location of the second pulley away from this straight line L. For instance, the rotation axis of the second pulley 122 can be offset from the straight line L in a direction O away from a cutting sector of the rotatable work tool 110. This type of configuration is illustrated in FIG. 6.

This can also be seen as the rotation axis of the second pulley 122 being offset from a plane P3 extending through and parallel with the center axis of the first pulley 121 and the center axis of the second gearwheel 142, in the direction O away from the cutting sector of the rotatable work tool 110.

The cutting sector of the work tool may comprise the lower forward quadrant Q1 of the work tool, which means that the second pulley can be offset in direction O to be further removed from an object to be cut. The first pulley 121, the second pulley 122, and the second gearwheel 142 then forms the corners of a triangle, as illustrated in FIG. 6. The work tool 110 is only schematically indicated in FIG. 6.

The drive ratio of the overall drive arrangement 100 including belt drive and gear transmission portions can be modified by changing pitch diameters of the gear transmission portion 140. For instance, a further reduction in speed can be obtained by using a smaller first gearwheel 141 compared to the second gearwheel 142. This is an advantage since it reduces mechanical stress on the belt, which then does not need the same dimensions as if the belt drive portion 120 had accounted for the entire drive ratio.

In other words, according to aspects, the second gearwheel 142 has a larger pitch diameter compared to the first gearwheel 141. Such gear transmission portions are shown, e.g., in FIG. 1 and in FIG. 6. The drive arrangement may for example be configured to have a drive ratio, including both belt drive and gear transmission portions, between 1:3 and 1:4, and preferably between 1:3.0 and 1:3.5, and more preferably 1:3.2.

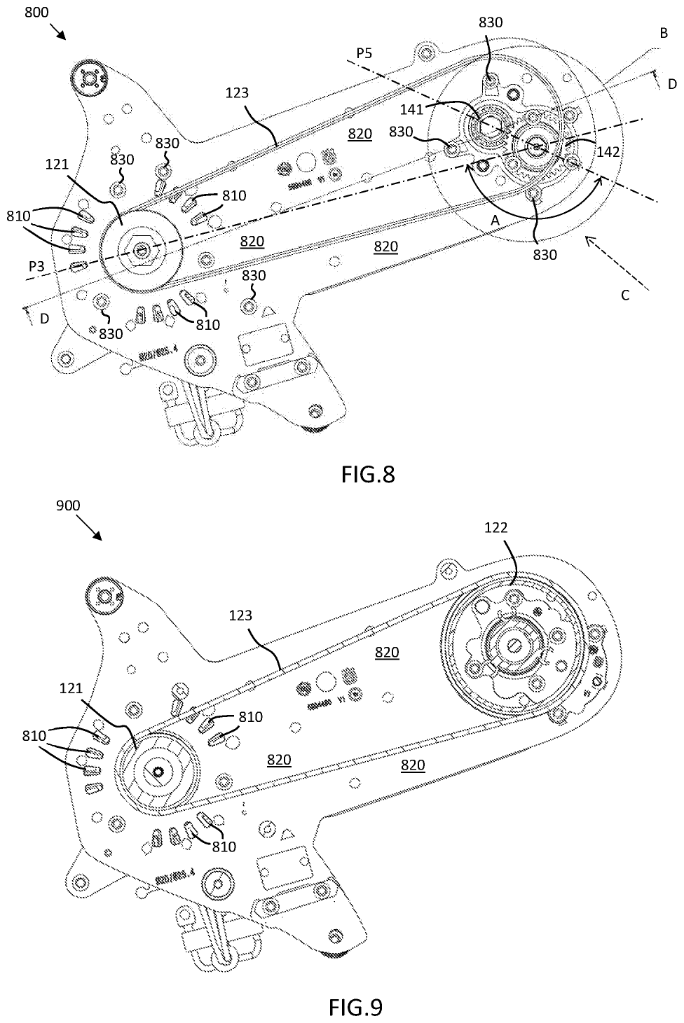

FIG. 6 illustrates an example drive arrangement 600, wherein a fifth plane P5 extends through and parallel with the center axis of the first gearwheel 141 and extends through and parallel with the center axis of the second gearwheel 142. The fifth plane P5 forms an angle A with respect to the third plane P3 that extends through and parallel with the center axis of the first pulley 121 and through and parallel with the center axis of the second gearwheel 142. The angle A is between 20 and 180 degrees, and preferably between 100 and 150 degrees, and more preferably about 135 degrees as illustrated schematically by the example in FIG. 6. This particular feature can be combined with the other example drive arrangements discussed above in connection to FIGS. 1-5 and is applicable for the drive arrangements illustrated in FIGS. 8-11. Notably, in the example drive arrangement 600 and also in many of the example drive arrangements discussed herein, the second gearwheel 142 has a pitch diameter which is smaller than a pitch diameter of the second pulley 122. This means that the cutting depth (when engaging an object in an approximate direction C) is improved compared to the case where a larger diameter second gearwheel is used.

According to some aspects, the gear transmission portion 140 is dimensioned to support a braking action by the power source to stop rotation by the rotatable work tool from a rotation velocity of about 50 m/sec in 5 ms, for a given belt dimension. Effectively this means that, due to the gear transmission portion 140, the power source can be parameterized more aggressively for a braking operation, without placing undue requirements on the belt drive portion, and the belt in particular. Consequently, the belt dimension can be reduced depending on the gear ratio of the gear transmission portion 140.

According to some aspects, a ratio of the first gearwheel 141 pitch diameter and the second gearwheel 142 pitch diameter is between 0.4 and 0.6, and preferably 0.56.

According to an example, the first gearwheel 141 has a pitch diameter between 20 and 35 mm, preferably 28 mm, and the second gearwheel 142 has a pitch diameter between 40 and 60 mm, preferably 50 mm.

Regarding the belt drive portion 120, the first pulley 121 may be associated with a pitch diameter between 30 and 40 mm, preferably 35.4 mm, and the second pulley 122 may be associated with a pitch diameter between 60 mm and 70 mm, preferably 64.85 mm.

According to aspects, a ratio between a pitch diameter of the first pulley 121 and a pitch diameter of the second pulley 122 is between 0.4 and 0.6, and preferably about 0.55.

Various types of drive belts can be used in the belt drive portion 120, such as a v-belt.

The belt drive portion 120 may also comprise a toothed belt, a timing belt, a cogged belt, cog belt, or synchronous belt. This is an advantage since the first pulley 121 can then be made very small, i.e., be dimensioned to have a very small pitch diameter on the order of 20 mm. By dimensioning the first pulley in this range, a further reduction in rotation speed is increased, and/or a smaller pitch diameter second pulley can be used. The toothed belt also provides for increased friction, which may be an advantage in some scenarios.

FIG. 2 shows an example drive arrangement where the gear transmission portion instead increases rotation speed of the work tool compared to a rotation speed of the second pulley 122. In other words, the second gearwheel 142 has a smaller pitch diameter than the first gearwheel 141, or wherein the first and second gearwheels have equal pitch diameters. This configuration may be advantageous in scenarios where extreme cutting depths are important, since the second gearwheel is now of a small pitch diameter.

FIG. 2 also shows an optional washer 150 arranged between the rotatable work tool 110 and the second gearwheel 142. This washer 150 provides increased mechanical integrity of the overall drive arrangement, which is an advantage. The washer also protects the drive transmission during very deep cuts, since the object to be cut hits the washer 150 before it hits the second gearwheel 142.

FIG. 3 shows an example power tool 300 comprising a rotatable work tool 110, a power source 130, and a drive arrangement according to the discussion above. The second pulley 122 is not shown in FIG. 3 to better see the gear transmission portion.

The power tool is associated with a baseline B defined by first and second ground support elements 310A, 310B. The quadrant Q1, where cuts are normally made, is shown located at the bottom right sector of the tool 110, in the view of FIG. 3. It is noted that the first gearwheel 141 has been offset away from quadrant Q1.

The rotatable work tool 110 is arranged to rotate in a down-cut direction (shown as R2 in FIG. 3), i.e., into a material to be cut.

The drive arrangement 300 comprises a cover 320 arranged to protect the belt drive, i.e., the first pulley 121, the second pulley 122, and the belt 123. The cover 320 is also arranged to protect the first gearwheel 141 and the second gearwheel 142. Notably, this cover 320 is positioned with an offset in a direction C away from a cutting region of the work tool, i.e., away from the quadrant Q1, in order to further optimize cutting depth.

According to some aspects, the power tool 300 comprises a blade guard 310 arranged to cover a portion of the rotatable work tool 110. This blade guard protects the user from debris during cutting operation and can also be configured to collect generated dust.

Details 400 of the blade guard 310 are illustrated in FIG. 4. The blade guard is arranged pivotably around a pivot point 410. Notably, a distance D3 from a center axis of the first pulley 121 to the pivot point is smaller than the distance D2 from the center axis of the first pulley 121 to the center axis 143 of the second gearwheel 142. Thus, the blade guard can be supported by a relatively large bushing at the pivot point without negatively impacting cutting depth, which is an advantage. 310A supporting arm 170 holds the work tool, the drive arrangement, and the blade guard.

According to some aspects, a difference between distances D2 and D3 corresponds to approximately half the pitch diameter of the second gearwheel 142.

According to some aspects, the first gearwheel 141 and the second gearwheel 142 are arranged on a straight line L. An axis of rotation of the blade guard 310 is parallel to the centre axis 143 of the second gearwheel 142 and located between the rotation axes of the first and second gearwheels along the straight line L.

According to some other aspects, the axis of rotation of the blade guard 310 is parallel to the centre axis 143 of the second gearwheel 142 and located between the rotation axes of the first and second gearwheels but offset from the straight line L.

FIG. 5 shows another view of some power tool details 500. An example drive arrangement arranged on a supporting arm 510 is illustrated together with a blade guard 310. It is appreciated that the power tool provides a large cutting depth in direction C, since the large second pulley 122 and the blade guard pivot point has been offset in direction C. It is appreciated that improved cutting depth in other directions, like direction C′ can be obtained by offsetting the second pulley 122 and blade guard pivot point in direction O.

FIG. 6 was discussed above. Notably, the drive arrangement 600 shown in FIG. 6 comprises a second pulley and first gearwheel which have been offset away from the quadrant Q1, in order to further optimize cutting depth. By moving the first pulley away from quadrant Q1, the belt and other moving parts are also better protected from mechanical impact and debris during cutting operation.

According to some aspects, a first plane P1 extends through a center axis of the first gearwheel 141 and parallel with the center axis of the first gear wheel, a second plane P2 extends through a center axis of the second gearwheel 142 and parallel with the center axis of the second gear wheel. The first plane P1 and the second plane P2 are parallel. The blade guard is arranged pivotable around a pivot point 410 arranged between the first plane P1 and the second plane P2 when the two planes are at maximum distance from each other. This means that the pivot point of the blade guard is somewhat retracted from the centre axis of the second gearwheel in the general direction of the first pulley 121. The first plane P1 and the second plane P2 are exemplified in FIG. 1. It is appreciated that the orientation of the first and second planes depend on the gearwheel geometry.

According to some other aspects, the pivot point 410 of the blade guard is offset from a third plane P3 extending through and parallel with the center axis of the first pulley 121 and extending through and parallel with the center axis of the second gearwheel 142, in a direction O away from a cutting sector of the rotatable work tool 110. This way the blade guard is not in the way, even when deep cuts are made. The third plane P3 coincides with line L in FIG. 1 and FIG. 6.

According to some further aspects, a fourth plane P4 extends through and parallel with the center axis of the first gearwheel 141. The fourth plane P4 is parallel to the third plane P3. The pivot point 410 of the blade guard is arranged between the third plane P3 and the fourth plane P4. The fourth plane P4 is exemplified in FIG. 6.

FIG. 7 is a flow chart illustrating a method for driving a rotatable work tool 110 using a drive arrangement 100, 200, 600. The method comprises configuring S1 a belt drive portion 120 comprising a first pulley 121 and a second pulley 122, wherein the first pulley is arranged to be powered by a power source 130, and wherein the second pulley has a larger pitch diameter than the first pulley;

configuring S2 a gear transmission portion 140 comprising a first gearwheel 141 and a second gearwheel 142, wherein the first gearwheel 141 is co-axially connected to the second pulley 122 and radially connected to the second gearwheel 142, and wherein the second gearwheel 142 is co-axially connected to the rotatable work tool 110; and driving S3 the rotatable work tool 110 by operating the power source 130.

According to aspects, a distance D1 from a center axis of the first pulley 121 to a center axis of the second pulley 122 is shorter than a distance D2 from the center axis of the first pulley 121 to a center axis of the second gearwheel 142.

FIGS. 8-11 schematically illustrate details of an example drive arrangement 800, 900, 1000, 1100 for a power tool according to the discussion above. The features illustrated in FIGS. 8-11 can be combined with any of the drive arrangements and power tools discussed above.

FIG. 8 shows a drive arrangement 800 with air vent apertures 810 for passing air into a volume 820 at least partly enclosed by the cover 320 discussed in connection to FIG. 3 above. The air vent apertures provide cooling for the drive arrangement, and optionally also generate an overpressure inside the volume 820, which overpressure prevents dirt an moisture from entering the volume 820 during operation.

FIGS. 8-10 also illustrate fastening members 830, here exemplified by bolts, for holding the drive arrangement in position with respect to the other parts of the power tool. Only a sub-set of the fastening members have been indicated in FIG. 8. FIG. 9 shows details 900 of the first and second pulleys 121, 122 and the drive belt 123.

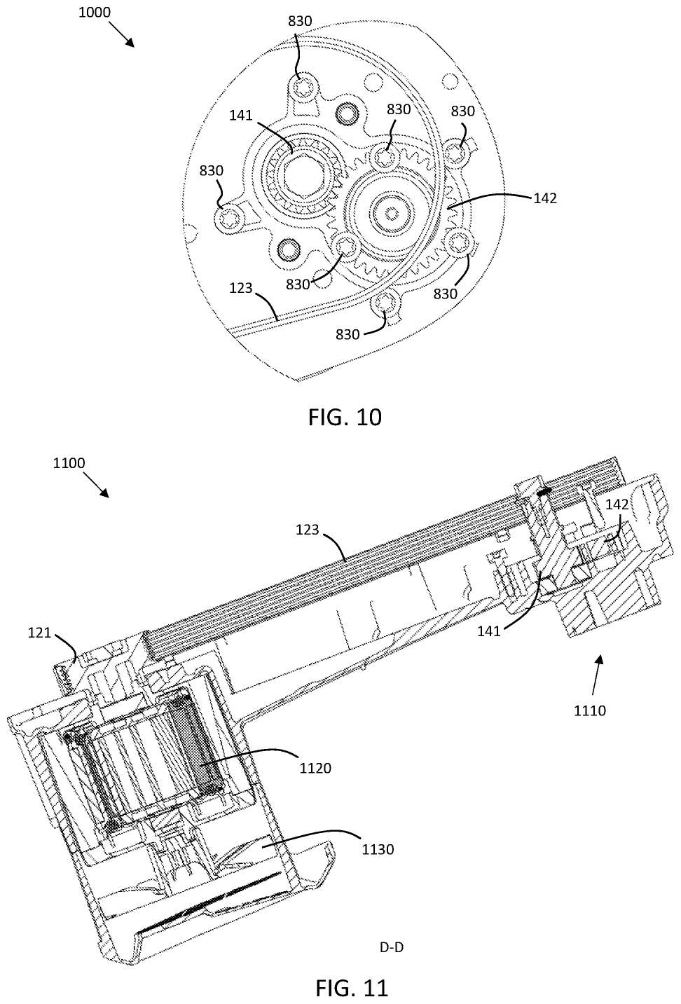

FIG. 10 illustrates details of the first and second gearwheels 141, 142 in relation to the drive belt 123. The second pulley 122 is not shown in FIG. 10. An example gear ratio between the first and second gearwheel is schematically illustrated in FIG. 10. FIG. 11 shows cross-section D-D indicated in FIG. 8. FIG. 11 provides an example drive arrangement 1100 showing means 1110 for holding the blade as well as the motor 1120 arranged to power the first pulley 121. The motor 1120 is an example power source 130. The motor 1120 is connected to the first pulley 121 on one end and to a fan 1130 on an opposite end. The fan generates a flow of air which cools the motor and also enters the volume 820 via the air vent apertures 810. FIG. 11 illustrates the efficient manner in which the various components of the drive arrangement are fit into a small volume.

The motor 1120 drives the first pulley 121. As the first pulley is rotated, force is transferred to the work tool via the belt 123 and the gears. The work tool is brought in rotation in an opposite direction compared to the first pulley. This drive arrangement provides for an efficient way to reduce tool speed down to speeds suitable for dry cutting operation. The generated dust is propelled at reduced speed, giving slower moving dust particles that are more easily handled, which is an advantage. The combination of belt drive and gear transmission allow for design freedom. For instance, the requirements on belt drive dimensions can be relaxed due to the gear transmission portion. Also, the work tool can be stopped abruptly without exerting excessive forces on, e.g., the belt drive portion. By means of the disclosed drive arrangement, requirements on the power output from the motor 1120 can be relaxed, which is an advantage.

The following list of numbered embodiments summarize some of the aspects disclosed herein.

1. A drive arrangement (100, 200, 600, 800, 900, 1000, 1100) for driving a rotatable work tool (110), the drive arrangement comprising;

a belt drive portion (120) comprising a first pulley (121) and a second pulley (122), wherein the first pulley is arranged to be powered by a power source (130) and to drive the second pulley via a belt (123), wherein the second pulley (122) has a larger pitch diameter than the first pulley (121); and

a gear transmission portion (140) comprising a first gearwheel (141) and a second gearwheel (142), wherein the first gearwheel (141) is co-axially connected to the second pulley (122) and radially connected to the second gearwheel (142), and wherein the second gearwheel (142) is arranged to be co-axially connected to the rotatable work tool (110).

2. The drive arrangement (100, 200, 600, 800, 900, 1000, 1100) according to embodiment 1, wherein a distance (D1) from a center axis of the first pulley (121) to a center axis of the second pulley (122) is smaller than a distance (D2) from the center axis of the first pulley (121) to a center axis (143) of the second gearwheel (142).

3. The drive arrangement (100, 600, 800, 900, 1000, 1100) according to any previous embodiment, wherein the second gearwheel (142) has a larger pitch diameter compared to the first gearwheel (141).

4. The drive arrangement (100, 600, 800, 900, 1000, 1100) according to embodiment 3, wherein a ratio of the first gearwheel (141) pitch diameter and the second gearwheel (142) pitch diameter is between 0.4 and 0.6, and preferably 0.56.

5. The drive arrangement (100, 600, 800, 900, 1000, 1100) according to any previous embodiment, wherein the first gearwheel (141) has a pitch diameter between 20 and 35 mm, preferably 28 mm, and wherein the second gearwheel (142) has a pitch diameter between 40 and 60 mm, preferably 50 mm.

6. The drive arrangement (200) according to embodiment 1 or 2, wherein the second gearwheel (142) has an equal or smaller pitch diameter compared to the first gearwheel (141).

7. The drive arrangement (100, 200, 600, 800, 900, 1000, 1100) according to any previous embodiment, wherein a ratio between a pitch diameter of the first pulley (121) and a pitch diameter of the second pulley (122) is between 0.4 and 0.6, and preferably about 0.55.

8. The drive arrangement (100, 200, 600, 800, 900, 1000, 1100) according to embodiment 7, wherein the first pulley (121) has a pitch diameter between 30 and 40 mm, preferably 35.4 mm, and wherein the second pulley (122) has a pitch diameter between 60 mm and 70 mm, preferably 64.85 mm.

9. The drive arrangement (100, 200, 600, 800, 900, 1000, 1100) according to any previous embodiment, wherein a drive ratio of the drive arrangement is between 1:3 and 1:4, and preferably between 1:3.0 and 1:3.5, and more preferably 1:3.2.

10. The drive arrangement (100, 200, 600, 800, 900, 1000, 1100) according to any previous embodiment, wherein the belt drive portion (120) belt (123) is a toothed belt.

11. The drive arrangement (100, 200, 600, 800, 900, 1000, 1100) according to any of embodiments 1-9, wherein the belt drive portion (120) belt (123) is a v-belt.

12. The drive arrangement (100, 200, 600, 800, 900, 1000, 1100) according to any previous embodiment, wherein the power source (130) is an electric motor.

13. The drive arrangement (100, 200, 600, 800, 900, 1000, 1100) according to any of embodiments 1-11, wherein the power source (130) is a combustion engine or a hybrid electric combustion engine.

14. The drive arrangement (100, 200, 600, 800, 900, 1000, 1100) according to any previous embodiment, wherein the power source (130) is arranged to operate at between 9000 and 10000 revolutions per minute, rpm, and wherein the rotatable work tool (110) is driven at between 2500 and 5000 rpm, and preferably around 3000 rpm.

15. The drive arrangement (100, 200, 600, 800, 900, 1000, 1100) according to any previous embodiment, wherein a direction of rotation (R1) of a drive shaft of the power source (130) is opposite to a direction of rotation (R2) of the rotatable work tool (110).

16. The drive arrangement (100, 200, 600, 800, 900, 1000, 1100) according to any previous embodiment, wherein the rotatable work tool (110) is arranged to rotate in a down-cut direction into a material to be cut.

17. The drive arrangement (100, 200, 600, 800, 900, 1000, 1100) according to any previous embodiment, wherein the gear transmission portion (140) is dimensioned to support a braking action by the power source to stop rotation by the rotatable work tool from a rotation velocity of about 50 m/sec in about 5 ms.

18. The drive arrangement (100, 200) according to any previous embodiment, wherein rotation axes of the first pulley (121), the second pulley (122), the first gearwheel (141) and the second gearwheel (142) are arranged on a straight line (L) between a center axis of the first pulley (121) and a center axis of the second gearwheel (142).

19. The drive arrangement (600, 800, 900, 1000, 1100) according to any of embodiments 1-17, wherein the rotation axis of the second pulley (122) is offset from the straight line (L) between the center axis of the first pulley (121) and the center axis of the second gearwheel (142), in a direction (O) away from a cutting sector of the rotatable work tool (110).

20. The drive arrangement (600, 800, 900, 1000, 1100) according to any of embodiments 1-17 and 19, wherein the rotation axis of the second pulley (122) is offset from a plane P3 extending through and parallel with the center axis of the first pulley (121) and the center axis of the second gearwheel (142), in a direction (O) away from a cutting sector of the rotatable work tool (110).

21. A power tool (300, 400, 500) comprising a rotatable work tool (110), a power source (130), and a drive arrangement (100, 200, 600) according to any previous embodiment.

22. The power tool (300, 400, 500) according to embodiment 21, comprising a blade guard (310) arranged to cover a portion of the rotatable work tool (110), the blade guard being arranged pivotable around a pivot point (410), wherein a distance (D3) from a center axis of the first pulley (121) to the pivot point is smaller than the distance (D2) from the center axis of the first pulley (121) to the center axis (143) of the second gearwheel (142).

23. The power tool (300, 400, 500) according to any of embodiments 21-22, wherein a difference between distances D2 and D3 corresponds to approximately half the pitch diameter of the second gearwheel (142).

24. The power tool (300, 400, 500) according to any of embodiments 21-23, wherein the first gearwheel (141) and the second gearwheel (142) are arranged on a straight line (L), wherein an axis of rotation of the blade guard (310) is parallel to the centre axis (143) of the second gearwheel (142) and located between the rotation axes of the first and second gearwheels along the straight line (L).

25. The power tool (300, 400, 500) according to any of embodiments 21-24, wherein a first plane P1 extends through a center axis of the first gearwheel (141) and parallel with the center axis of the first gear wheel, wherein a second plane P2 extends through a center axis of the second gearwheel (142) and parallel with the center axis of the second gear wheel, where the first plane P1 and the second plane P2 are parallel, wherein the blade guard is arranged pivotable around a pivot point (410) arranged between the first plane P1 and the second plane P2 when the two planes are at maximum distance from each other.

26. The power tool (300, 400, 500) according to any of embodiments 21-25, wherein the pivot point (410) of the blade guard is offset from the third plane P3 extending through and parallel with the center axis of the first pulley (121) and extending through and parallel with the center axis of the second gearwheel (142), in a direction (O) away from a cutting sector of the rotatable work tool (110).

27. The power tool (300, 400, 500) according to any of embodiments 21-26, wherein a fourth plane P4 extends through and parallel with the center axis of the first gearwheel (141), wherein the fourth plane P4 is parallel to the third plane P3, wherein the pivot point (410) of the blade guard is arranged between the third plane P3 and the fourth plane P4.

28. A method for driving a rotatable work tool (110) using a drive arrangement (100, 200, 600), comprising;

configuring (S1) a belt drive portion (120) comprising a first pulley (121) and a second pulley (122), wherein the first pulley is arranged to be powered by a power source (130) and to drive the second pulley via a belt (123), and wherein the second pulley has a larger pitch diameter than the first pulley;

configuring (S2) a gear transmission portion (140) comprising a first gearwheel (141) and a second gearwheel (142), wherein the first gearwheel (141) is co-axially connected to the second pulley (122) and radially connected to the second gearwheel (142), and wherein the second gearwheel (142) is co-axially connected to the rotatable work tool (110); and

driving (S3) the rotatable work tool (110) by operating the power source (130).

1. A handheld cut-off saw for cutting concrete and stone, the handheld cut-off saw comprising a drive arrangement for driving a circular cutting tool the drive arrangement comprising;
a belt drive portion comprising a first pulley and a second pulley, wherein the first pulley is arranged to be powered by a power source and to drive the second pulley via a belt, wherein the second pulley has a larger pitch diameter than the first pulley; and
a gear transmission portion comprising a first gearwheel and a second gearwheel, wherein the first gearwheel is co-axially connected to the second pulley and radially connected to the second gearwheel, and wherein the second gearwheel is arranged to be co-axially connected to the circular cutting tool.

2. The handheld cut-off saw according to claim 1, wherein the second gearwheel has a pitch diameter smaller than a pitch diameter of the second pulley.

3. The handheld cut-off saw according to claim 1, wherein a first distance from a center axis of the first pulley to a center axis of the second pulley is smaller than a second distance from the center axis of the first pulley to a center axis.

4. The handheld cut-off saw according to claim 1, wherein the second gearwheel has a larger pitch diameter compared to the first gearwheel.

5. The handheld cut-off saw according to claim 4, wherein a ratio of the first gearwheel pitch diameter and the second gearwheel pitch diameter is between 0.4 and 0.6.

6. The handheld cut-off saw according to claim 1, wherein the first gearwheel has a pitch diameter between 20 and 35 mm, and wherein the second gearwheel has a pitch diameter between 40 and 60 mm.

7. The handheld cut-off saw according to claim 1, wherein the second gearwheel has an equal or smaller pitch diameter compared to the first gearwheel.

8. The handheld cut-off saw according to claim 1, wherein a ratio between a pitch diameter of the first pulley and a pitch diameter of the second pulley is between 0.4 and 0.6, and
wherein a drive ratio of the drive arrangement is between 1:3 and 1:4.

9. The handheld cut-off saw according to claim 8, wherein the first pulley has a pitch diameter between 30 and 40 mm, and wherein the second pulley has a pitch diameter between 60 mm and 70 mm.

10. (canceled)

11. The handheld cut-off saw according to claim 1, wherein the belt drive portion belt is a toothed belt or a v-belt.

12. (canceled)

13. The handheld cut-off saw according to claim 1, wherein the power source is an electric motor, a combustion engine or a hybrid electric combustion engine.

14. (canceled)

15. The handheld cut-off saw according to claim 1, wherein the power source is arranged to operate at between 9000 and 10000 revolutions per minute, rpm,
wherein the circular cutting tool is driven at between 2500 and 5000 rpm, and
wherein the circular cutting tool is arranged to rotate in a down-cut direction into a material to be cut.

16. (canceled)

17. (canceled)

18. The handheld cut-off saw according to claim 1, wherein the gear transmission portion is dimensioned to support a braking action by the power source to stop rotation by the circular cutting tool from a rotation velocity of about 50 m/sec in about 5 ms,
wherein a direction of rotation of a drive shaft of the power source is opposite to a direction of rotation of the circular cutting tool, and
wherein rotation axes of the first pulley, the second pulley, the first gearwheel and the second gearwheel are arranged on a straight line between a center axis of the first pulley and a center axis of the second gearwheel.

19. (canceled)

20. (canceled)

21. The handheld cut-off saw according to claim 1, wherein a rotation axis of the second pulley is offset from a plane extending through and parallel with the center axis of the first pulley and through the center axis of the second gearwheel, in a direction away from a cutting sector of the circular cutting tool, or
wherein the rotation axis of the second pulley is offset from a straight line between the center axis of the first pulley and the center axis of the second gearwheel, in the direction away from the cutting sector of the circular cutting tool.

22. The handheld cut-off saw according to claim 3, comprising a blade guard arranged to cover a portion of the circular cutting tool, the blade guard being arranged pivotable around a pivot point, wherein a third distance from a center axis of the first pulley to the pivot point is smaller than the second distance from the center axis of the first pulley to the center axis of the second gearwheel, and wherein a difference between the second and third distances corresponds to approximately half a pitch diameter of the second gearwheel.

23. (canceled)

24. The handheld cut-off saw according to claim 22, wherein the first gearwheel and the second gearwheel are arranged on a straight line, wherein an axis of rotation of the blade guard is parallel to the centre axis of the second gearwheel and located between the rotation axes of the first and second gearwheels along the straight line.

25. The handheld cut-off saw according to claim 22, wherein a first plane extends through a center axis of the first gearwheel and parallel with the center axis of the first gear wheel, wherein a second plane extends through a center axis of the second gearwheel and parallel with the center axis of the second gear wheel, wherein the first plane and the second plane are parallel, wherein the blade guard is arranged pivotable around a pivot point arranged between the first plane and the second plane when the two planes are at maximum distance from each other.

26. The handheld cut-off saw according to claim 25, wherein the pivot point of the blade guard is offset from a third plane extending through and parallel with the center axis of the first pulley and extending through and parallel with the center axis of the second gearwheel, in a direction away from a cutting sector of the circular cutting tool.

27. The handheld cut-off saw according to claim 26, wherein a fourth plane extends through and parallel with the center axis of the first gearwheel, wherein the fourth plane is parallel to the third plane, wherein the pivot point of the blade guard is arranged between the third plane and the fourth plane.

28. The handheld cut-off saw according to claim 27, comprising a drive arrangement wherein a fifth plane extends through and parallel with the center axis of the first gearwheel and also through and parallel with the center axis of the second gearwheel, wherein the fifth plane forms an angle with respect to the third plane extending through and parallel with the center axis of the first pulley and through and parallel with the center axis of the second gearwheel, wherein the angle is between 20 and 180 degrees.
